(19) United States
(12) Patent Application Publication
(10) Pub. No.: US 2004/0173568 A1
(43) Pub. Date: Sep. 9, 2004

(54) Method for dry etching magnetic material, magnetic material, and magnetic recording medium

(75) Inventor: Kazuhiro Hattori, Chuo-ku (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/791,717

(22) Filed: Mar. 4, 2004

(30) Foreign Application Priority Data
Mar. 5, 2003 (JP) 2003-058382

(51) Int. Cl. B44C 1/22

(52) U.S. Cl. 216/22

(57) ABSTRACT

A method of dry etching a magnetic material which is capable of precise etching of fine etching target areas of a magnetic material with target widths of 150 nm or less, wherein the ratio of the flow rate of carbon monoxide gas relative to the total flow rate of reactive gas is within a range from 1% to 40%.

### BACKGROUND OF THE INVENTION

1. Field of the Invention

The present invention relates to a dry etching method for fine processing of a magnetic material, as well as a magnetic material and a magnetic recording medium.

2. Description of the Related Art

Conventionally, reactive ion etching using CO (carbon monoxide) gas with an added nitrogen based compound gas such as ammonia (NH₃) as the reactive gas is the most widely known technique for fine processing of a magnetic material (for example, see Japanese Patent Laid-Open Publication No. Hei 12-322710).

In this type of reactive ion etching, the transition metal of the magnetic material and the CO gas are reacted together to generate a transition metal carbonyl compound with a low bond energy, and this transition metal carbonyl compound is then removed by a sputtering action, enabling the magnetic material to be processed into a desired shape. The gas of the nitrogen based compound is added to suppress the decomposition of CO into C (carbon) and O (oxygen), and thus promote the formation of the transition metal carbonyl compound.

Using this type of reactive ion etching, fine processing can be performed on a variety of magnetic materials, including thin-film magnetic layers of magnetic recording media.

For example, the magnetic recording media of hard disks and the like have undergone significant increases in surface recording density as a result of improvements including miniaturization of the magnetic particles that make up the magnetic recording medium, development of new materials, and miniaturization of head processing technology, although improvements based on these types of methods such as miniaturization of the magnetic particles are now approaching their limit, and discrete type magnetic recording media, in which a thin-film magnetic layer is partitioned into a plurality of minute recording elements, have been proposed (for example, see Japanese Patent Laid-Open Publication. No. Hei 06-259709) as an example of magnetic recording media that will enable further improvements in surface recording density. Production of this type of discrete type magnetic recording medium requires the fine processing of minute areas with widths of 1 μm or less, and it is believed that the reactive ion etching technique described above is capable of this level of fine processing.

However, when practical tests were conducted using CO gas containing added NH₃ gas as the reactive gas to perform reactive ion etching of a recording layer, it was discovered that as the width of the etching target area was narrowed, the speed of the etching tended to slow, and the anisotropy of the etching process tended to be lost, causing a deterioration in the processing precision. When the width of the etching target area was reduced to 150 nm or narrower, these tendencies became particularly marked, and precise processing became difficult.

### SUMMARY OF THE INVENTION

The present invention takes the problems described above into consideration, and has an object of providing a method of dry etching a magnetic material which is capable of precise etching of very fine etching target areas of the magnetic material with target widths of 150 nm or less.

The present invention resolves the problems outlined above by significantly reducing the ratio of the flow rate of carbon monoxide gas relative to the total flow rate of the reactive gas when compared with conventional values.

The reasons why reducing the ratio of the flow rate of carbon monoxide gas results in an improvement in the processing precision for fine areas are not entirely clear, although the following factors are thought to be significant.

Even when a gas of a nitrogen based compound is added, a small quantity of the carbon monoxide still decomposes into carbon and oxygen. Adhesion of this carbon to the surface of the magnetic material, and the formation of oxides through the reaction of oxygen with the magnetic material inhibit the etching of the magnetic material. Adhesion of this type of foreign matter to the side walls of grooves functions as a mask for the etching process, and can actually contribute to the formation of a precise groove, but adhesion to the bottom surface of a groove results in inhibition of the etching process.

In those cases where the width of the etching target area, that is, the width of the groove, is large, the surface area of the section that undergoes carbonylation and subsequent removal is also large, and it is thought that as a result, even if foreign matter adheres to a portion of the bottom surface of the groove, this foreign matter is removed together with the carbonylated section.

In contrast, when the width of the groove is narrow, the surface area of the section that undergoes carbonylation and subsequent removal is also small, and consequently sections with adhered foreign matter are more likely to stabilize and remain on the bottom surface of the groove. As a result, it is believed that the bottom surface of the groove is gradually covered with foreign matter such as carbon and oxides, thereby inhibiting progress of the etching process, and causing a deterioration in the precision of the shape of the groove.

Accordingly, the inventors of the present invention surmised that by reducing the relative flow rate of carbon monoxide and increasing the relative flow rate of the nitrogen based compound gas, decomposition of the carbon monoxide, and consequently formation of foreign matter, could be significantly reduced, thereby enabling the etching process to proceed reliably, and precise processing to be realized, even in cases in which the etching target area is very fine.

Conventionally the carbon monoxide gas, which performs the function of carbonylating the magnetic material, has been considered the primary component of the reactive gas, with the gas of the nitrogen based compound such as NH₃ acting merely as an auxiliary component for reducing decomposition of the carbon monoxide gas, and consequently the lower limit for the flow rate ratio of carbon monoxide gas was thought to be approximately 50%. In contrast in the present invention, the ratio of the flow rate of carbon monoxide gas relative to the total flow rate of the reactive gas is reduced to less than a half, so that the gas of the nitrogen based compound effectively becomes the primary component. Accordingly, the present invention is based on a concept and viewpoint that are completely different from conventional thinking.

Accordingly, various exemplary embodiments of the invention provide as described below.

(1) A method for dry etching a magnetic material in which the magnetic material is subjected to fine processing by reactive ion etching using, as the reactive gas, carbon monoxide gas containing an added gas of a nitrogen based compound, wherein the ratio of the flow rate of the carbon monoxide gas relative to the total flow rate of the reactive gas is within a range from 1% to 40%.

(2) The method for dry etching a magnetic material according to (1), wherein the ratio of the flow rate of the carbon monoxide gas relative to the total flow rate of the reactive gas is equal to, or less than, 30%.

(3) The method for dry etching a magnetic material according to (1), wherein the ratio of the flow rate of the carbon monoxide gas relative to the total flow rate of the reactive gas is equal to, or less than, 20%.

(4) The method for dry etching a magnetic material according to (1), wherein the ratio of the flow rate of the carbon monoxide gas relative to the total flow rate of the reactive gas is equal to, or less than, 15%.

(5) The method for dry etching a magnetic material according to any one of (1) to (4), wherein the ratio of the flow rate of the carbon monoxide gas relative to the total flow rate of the reactive gas is equal to, or more than, 5%.

(6) The method for dry etching a magnetic material according to any one of (1) to (4), wherein the ratio of the flow rate of the carbon monoxide gas relative to the total flow rate of the reactive gas is equal to, or more than, 10%.

(7) The method for dry etching a magnetic material according to any one of (1) to (6), wherein the temperature in the vicinity of the magnetic material is maintained at 300° C. or lower, while the magnetic material is subjected to fine processing.

(8) The method for dry etching a magnetic material according to any one of (1) to (6), wherein the temperature in the vicinity of the magnetic material is maintained at 200° C. or lower, while the magnetic material is subjected to fine processing.

(9) A magnetic material, wherein an etching target area thereof is etched using the method for dry etching a magnetic material according to any one of (1) to (8), wherein the width of the area is equal to, or less than, 150 nm.

(10) A magnetic material, wherein an etching target area thereof is etched using the method for dry etching a magnetic material according to any one of (1) to (8), wherein the width of the area is equal to, or less than, 100 nm.

(11) The magnetic material according to (9) or (10), wherein a processed surface is etched to be inclined at an angle of 45 to 85° relative to a surface of the material.

(12) A magnetic recording medium comprising the magnetic material according to any one of (9) to (11).

(13) A reactive ion etching device comprising: a diffusion chamber for housing a processing target body; reactive gas supply means for supplying carbon monoxide gas with an added gas of a nitrogen based compound as a reaction gas into the diffusion chamber and for restricting the ratio of the carbon monoxide gas flow rate relative to the total flow rate of the reactive gas to a value within a range from 1 to 40%; and temperature adjustment means for maintaining the temperature in the vicinity of the magnetic material in the diffusion chamber at 300° C. or lower.

### BRIEF DESCRIPTION OF THE DRAWINGS

FIG. 1 is a side view incorporating a partial block diagram showing a schematic illustration of the structure of a reactive ion etching apparatus used for processing a thin-film magnetic layer according to an embodiment of the present invention;

FIG. 2 is a side sectional view showing a schematic illustration of the structure of a processing target body that is processed by the same reactive ion etching apparatus;

FIG. 3 is a flowchart showing the steps for processing the target body;

FIG. 4 is a side sectional view showing a schematic illustration of the shape of the processing target body following the transfer of grooves corresponding with a partition pattern into the resist layer;

FIG. 5 is a side sectional view showing a schematic illustration of the shape of the processing target body following the removal of the second mask layer from the bottom surfaces of the grooves;

FIG. 6 is a side sectional view showing a schematic illustration of the shape of the processing target body following the removal of the first mask layer from the bottom surfaces of the grooves;

FIG. 7 is a side sectional view showing a schematic illustration of the shape of the processing target body following partitioning of the thin-film magnetic layer;

FIG. 8 is a side sectional view showing a schematic illustration of the shape of the processing target body following the removal of the remaining first mask layer from the upper surface of the recording elements;

FIGS. 9(A) to 9(C) are a series of photographs showing side sectional views of processing target bodies with partitioned thin-film magnetic layers according to an example of the present invention;

FIG. 10 is a plan view photograph showing an enlargement of the surface state of each of the same processing target bodies;

FIG. 11(A) to 11(C) are a series of photographs showing side sectional views of processing target bodies with partitioned thin-film magnetic layers according to a comparative example of the present invention; and

FIG. 12 is a plan view photograph showing an enlargement of the surface state of each of the same processing target bodies.

### DETAILED DESCRIPTION OF THE PREFERRED EMBODIMENTS

As follows is a detailed description of preferred embodiments of the present invention, with reference to the drawings.

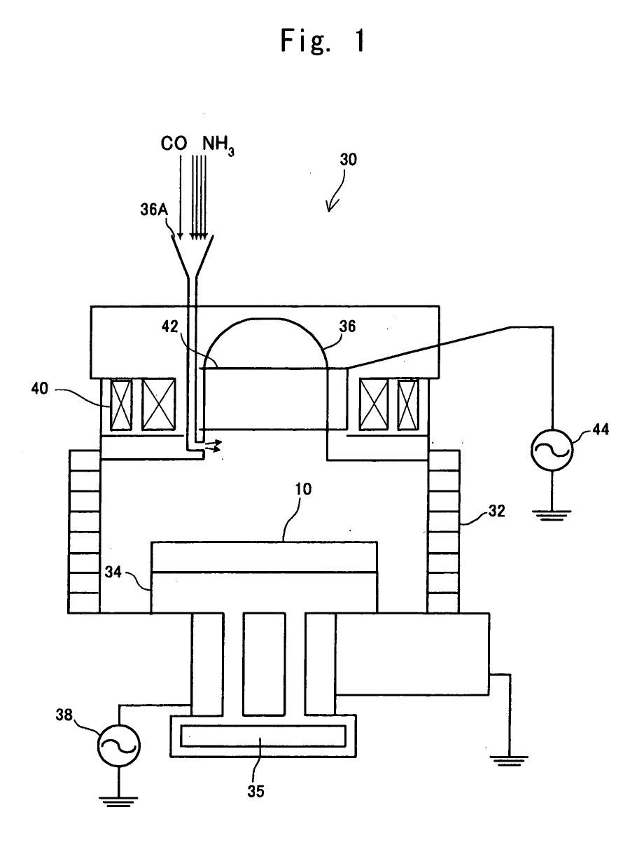

FIG. 1 is a side view incorporating a partial block diagram showing a schematic illustration of the structure of a reactive ion etching apparatus according to an embodiment of the present invention.

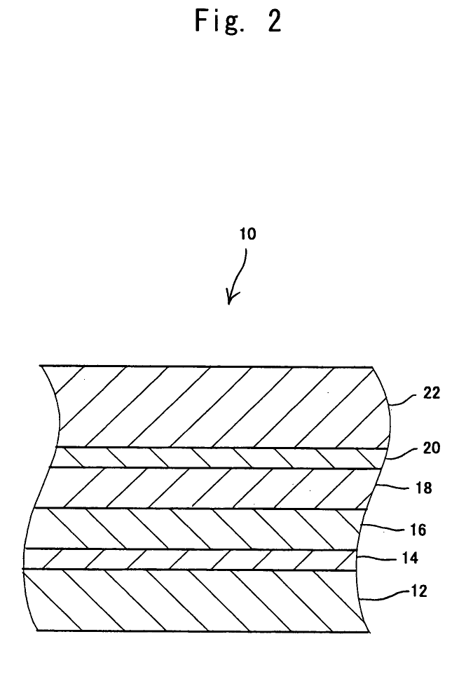

The characteristic feature of this embodiment lies within the processing step of the thin-film magnetic layer (the magnetic material) using this reactive ion etching apparatus. The other steps can be the same as conventional processes, and as such their description is omitted here. First, in order to facilitate a better understanding of the thin-film magnetic layer processing step, a simple description is given of the structure of the processing target body on which the thin-film magnetic layer is formed. FIG. 2 is a side sectional view showing a schematic illustration of the structure of the processing target body.

The processing target body 10 comprises a Si (silicon) substrate 12 with a backing orientation layer 14, a thin-film magnetic layer 16, a first mask layer 18, a second mask layer 20, and a resist layer 22 formed sequentially thereon.

The material of the backing orientation layer 14 is either Cr (chromium), a Cr alloy, CoO, MgO or NiO or the like, and the material of the thin-film magnetic layer 16 is a Co (cobalt) alloy. The material of the first mask layer 18 is Ta (tantalum), the material of the second mask layer 20 is Ni (nickel), and the material of the resist layer 22 is a positive resist (ZEP520, manufactured by Zeon Corporation).

Returning to FIG. 1, the reactive ion etching apparatus 30 utilizes a helicon-wave plasma system, and comprises a diffusion chamber 32, an ESC (electrostatic chuck) stage electrode 34 for retaining the processing target body 10 inside the diffusion chamber 32, a cooling device (temperature adjustment means) 35 for cooling the stage electrode 34, and a quartz bell jar 36 for generating a plasma.

The ESC stage electrode 34 is connected to a bias power supply 38 which applies a bias voltage to the electrode. The bias power supply 38 is an AC power supply with a frequency of 1.6 MHz.

The ESC stage electrode 34 could also be replaced with a stage that retains the sample in a mechanical manner.

The cooling device 35 cools the ESC stage electrode 34 by supplying a liquid refrigerant such as water, ethylene glycol or a florinate, and/or a gaseous refrigerant such as helium gas to the ESC stage electrode 34.

The quartz bell jar 36 opens into the diffusion chamber 32 at the bottom edge of the jar, and connects to a gas inlet 36A that introduces the reactive gas into a position near the bottom edge of the bell jar. Furthermore, an electromagnetic coil 40 and an antenna 42 are positioned around the periphery of the quartz bell jar 36, and the antenna 42 is connected to a plasma generation power supply 44. The plasma generation power supply 44 is an AC power supply with a frequency of 13.56 MHz.

Next is a description of a method of processing the processing target body 10.

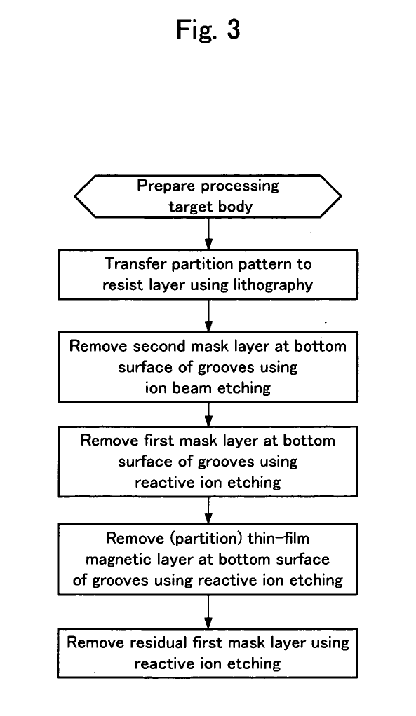

FIG. 3 is a flowchart showing the flow during processing of the target body 10.

First, the processing target body 10 is prepared. The processing target body 10 is formed by using sputtering to form sequentially, on top of a Si substrate 12, a backing orientation layer 14 with a thickness of 300 to 3000 Å, a thin-film magnetic layer 16 with a thickness of 100 to 300 Å, a first mask layer 18 with a thickness of 100 to 500 Å, and a second mask layer 20 with a thickness of 100 to 300 Å, and then using spin coating to apply a resist layer 22 with a thickness of 300 to 3000 Å.

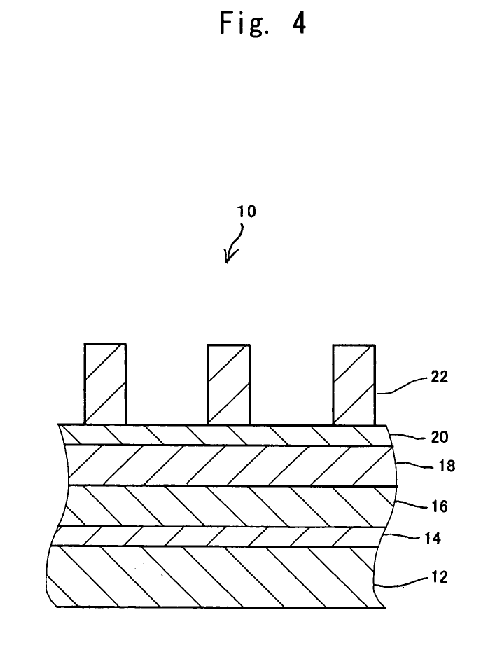

The resist layer 22 of this processing target body 10 is then exposed using an electron beam exposure apparatus (not shown in the drawings), and subsequently developed for 5 minutes at room temperature using ZED-N50 (manufactured by Zeon Corporation) to remove the exposed sections, thereby forming a plurality of grooves with minute spacings positioned therebetween, as shown in FIG. 4.

Next, an ion beam etching device (not shown in the drawings) using Ar (argon) gas is used to remove the second mask layer 20 from the bottom surfaces of the grooves, as shown in FIG. 5. During this process, a small quantity of those areas of the resist layer 22 outside the grooves is also removed.

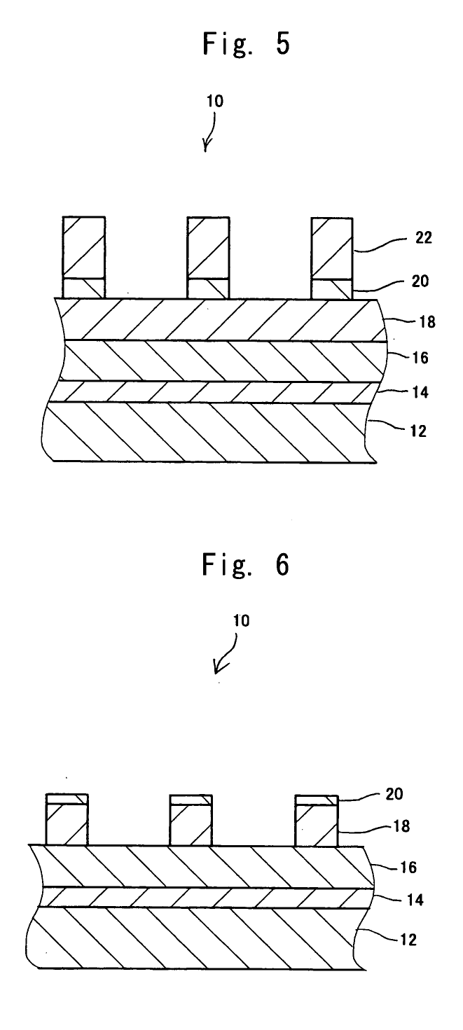

Subsequently, a reactive ion etching device (not shown in the drawings) using either CF₄ gas or SF₆ gas is used to remove those sections of the first mask layer 18 at the bottom surfaces of the grooves, as shown in FIG. 6. At this time, the remaining quantity of the areas of the resist layer 22 outside the grooves is completely removed. Furthermore, a portion of those areas of the second mask layer 20 outside the grooves is also removed, although a small quantity still remains.

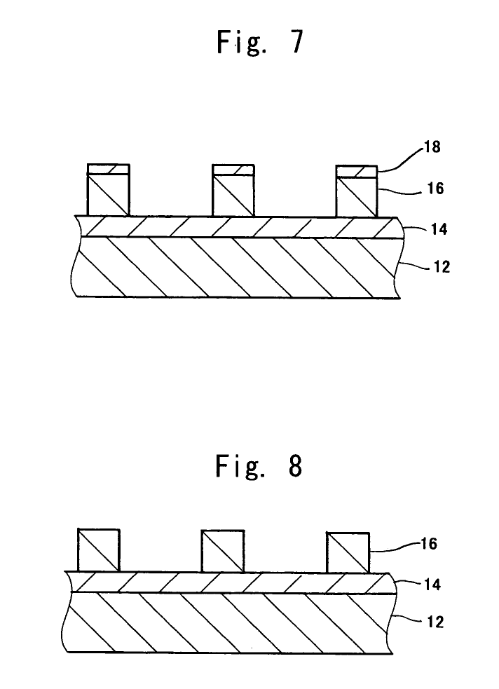

Next, the reactive ion etching apparatus 30 described above is used to remove those sections of the thin-film magnetic layer 16 at the bottom surfaces of the grooves, as shown in FIG. 7.

Specifically, the processing target body 10 is mounted and secured onto the ESC stage electrode 34, and a bias voltage is applied. The electromagnetic coil 40 then generates a magnetic field, and when the antenna 42 emits helicon waves, these helicon waves are transmitted along the magnetic field, generating a high density plasma inside the quartz bell jar 36. When CO gas and NH₃ gas are then supplied through the gas inlet 36A, radicals are formed and diffuse into the diffusion chamber 32, carbonylating the surface of the thin-film magnetic layer 16 of the processing target body 10. Furthermore, ions are attracted by the bias voltage and collide with the processing target body 10 in a substantially perpendicular manner, thereby removing the surface of the carbonylated thin-film magnetic layer 16.

During this process, the ratio of the CO gas flow rate relative to the total flow rate of the reactive gas containing both CO gas and NH₃ gas is restricted to a value within a range from 1 to 40%. Furthermore, the ESC stage electrode 34 is cooled with the cooling device 35 so as to maintain the temperature in the vicinity of the processing target body 10 at 200° C. or lower. By adopting these measures, even if the widths of the etching target areas of the thin-film magnetic layer 16 that are exposed through the first mask layer 18 (the widths of the grooves) are very fine, and for example 150 nm or less, etching of these target areas can still be conducted in a precise manner in a substantially perpendicular direction (the thickness direction), thereby partitioning the thin-film magnetic layer 16 into a plurality of recording elements. The recording elements are formed with side surfaces (the processed surfaces) that are inclined at an angle of 45 to 85° relative to the element surface.

During this reactive ion etching process, the remaining quantity of those areas of the second mask layer 20 outside the grooves is completely removed. Furthermore, a large proportion of those areas of the first mask layer 18 outside the grooves is also removed, although a small quantity still remains on the upper surface of the recording elements.

Subsequently, a reactive ion etching device (not shown in the drawings) using either CF₄ gas or SF₆ gas is used to completely remove those sections of the first mask layer 18 remaining on the upper surface of the recording elements, as shown in FIG. 8. A reactive ashing device (not shown in the drawings) using either CF₄ gas or SF₆ gas could also be used to remove the remaining sections of the first mask layer 18 on the upper surface of the recording elements.

This completes the fine processing of the thin-film magnetic layer 16.

During the dry etching of the thin-film magnetic layer 16, by restricting the ratio of the CO gas flow rate relative to the total flow rate of CO gas and NH₃ gas to a value within the aforementioned range from 1 to 40%, etching processing can be conducted with a high level of precision for very fine etching target areas with widths of 150 nm or less. This enables the production of a variety of products that require fine processing of a magnetic material, including discrete type magnetic recording media.

Typically, no new equipment need be provided in order to adjust the ratio of the CO gas flow rate relative to the total flow rate of CO gas and NH₃ gas to a value within the range from 1 to 40%. Furthermore, even in those cases where new equipment is required, simple devices are adequate. Accordingly, a dry etching method for magnetic members according to an embodiment of the present invention is very low cost.

In addition, in those cases where etching is conducted on minute etching target areas with widths of 150 nm or less, restricting the ratio of the CO gas flow rate relative to the total flow rate of CO gas and NH₃ gas to a value within the range from 1 to 40% enables the etching speed to be increased markedly compared with a conventional reactive ion etching method, meaning a dry etching method for magnetic members according to an embodiment of the present invention offers excellent production efficiency.

In the present embodiment, the reactive gas for the reactive ion etching process used for etching the thin-film magnetic layer 16 utilized CO gas containing added NH₃ gas, but the present invention is not restricted to this configuration, and CO gas containing a gas of a different nitrogen based compound capable of suppressing the decomposition of CO, such as an amine, may also be used as the reactive gas.

Furthermore, in the present embodiment the reactive ion etching apparatus 30 for etching the thin-film magnetic layer 16 used a helicon wave plasma system, but the present invention is not restricted to this type of system, and reactive ion etching apparatus based on other systems such as parallel plate systems, magnetron systems, two frequency excitation systems, ECR (Electron Cyclotron Resonance) systems, and ICP (Inductively Coupled Plasma) systems can also be used.

In addition, in the present embodiment a resist layer and two mask layers of different materials are formed on top of the thin-film magnetic layer 16, and a three stage dry etching process is used to form grooves in the processing target body 10 and partition the thin-film magnetic layer 16, but there are no particular restrictions on the materials for the resist layer and the mask layers, nor on the number of layers formed, provided a mask layer that displays resistance to reactive ion etching using a reactive gas comprising CO gas with an added nitrogen based compound gas can be formed with good precision on top of the thin-film magnetic layer 16.

Furthermore, in the present embodiment the processing target body 10 is a test sample in which the thin-film magnetic layer 16 is formed on top of a Si substrate 12 with a backing orientation layer 14 disposed therebetween, but the present invention can also be applied to the processing of a variety of different recording media and apparatus produced using magnetic materials, including magnetic disks such as hard disks, magneto-optical disks, magnetic tapes, and magnetic heads.

### EXAMPLE

Three processing target bodies 10 were prepared by forming grooves with widths of 300 nm, 60 nm, and 40 nm respectively in the first mask layers 18. Using reactive ion etching with CO gas containing added NH₃ gas as the reactive gas, as described in the above embodiment, the exposed sections of the thin-film magnetic layer 16 of each sample were then etched under the conditions listed below.

Gas pressure inside diffusion chamber 32: 1.0×0.10⁻⁵ Pa

Reactive gas pressure: 0.4 Pa

CO gas flow rate: 12.5 ccm

NH₃ gas flow rate: 87.5 ccm

Stage temperature: 200° C.

Source power: 1000 W

RF applied power: 1.65 W/cm²

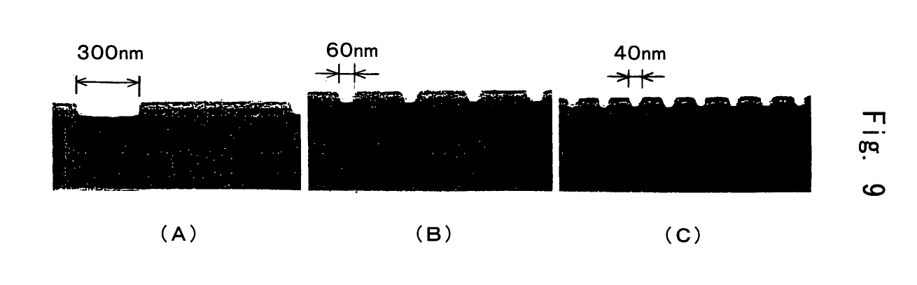

As shown in FIG. 9(A) to FIG. 9(C), the exposed sections of the thin-film magnetic layer 16 in each of the three processing target bodies 10 were removed with good precision in the thickness direction.

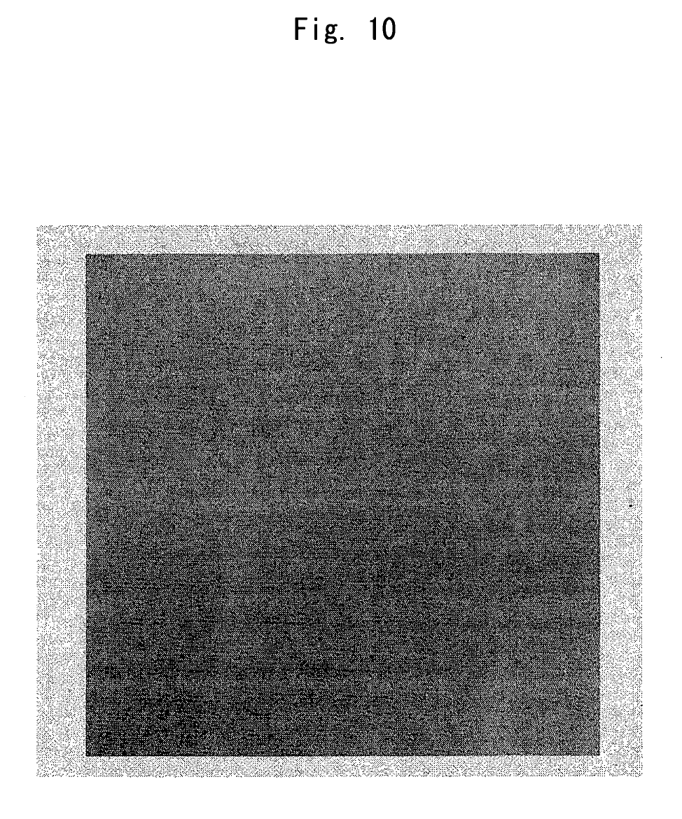

Furthermore, as shown in FIG. 10, the surface state of the thin-film magnetic layers 16 was good, with no peeling visible in any of the samples.

### Comparative Example 1

Three processing target bodies 10 were prepared in the same manner as the example described above, by forming grooves with widths of 300 nm, 60 nm, and 40 nm respectively in the first mask layers 18. With the exception of altering the flow rates of the CO gas and the NH₃ gas as shown below, the exposed sections of the thin-film magnetic layer 16 of each sample were then etched under the same conditions as the example above.

CO gas flow rate: 50.0 ccm

NH₃ gas flow rate: 50.0 ccm

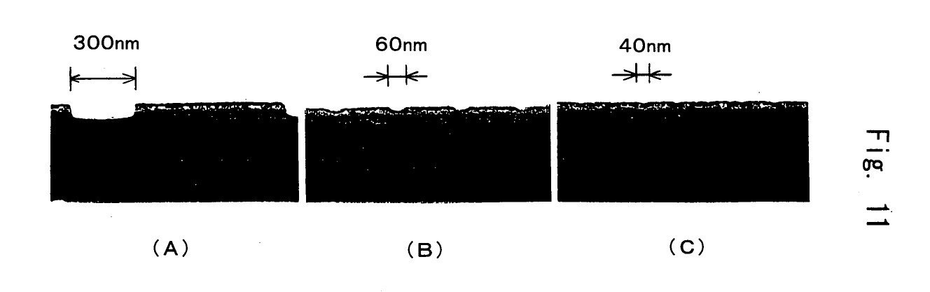

As shown in FIG. 11(A) through FIG. 11(C), although the etching target area of the thin-film magnetic layer 16 was removed with good precision in the thickness direction, in a similar manner to the examples above, in the sample in which the width of the exposed sections was 300 nm, in the sample in which the width of the exposed sections was 60 nm, the etching depth was unsatisfactory and the precision of the etched shape was also poor. Furthermore, in the sample in which the width of the exposed sections was 40 nm, the etching effectively failed to proceed. No peeling of the thin-film magnetic layers 16 was observed.

### Comparative Example 2

Three processing target bodies 10 were prepared in the same manner as the example described above, by forming grooves with widths of 300 nm, 60 nm, and 40 nm respectively in the first mask layers 18. With the exception of not conducting cooling of the stage, and allowing the stage temperature to rise above 300° C., the exposed sections of the thin-film magnetic layer 16 of each sample were then etched under the same conditions as the example above.

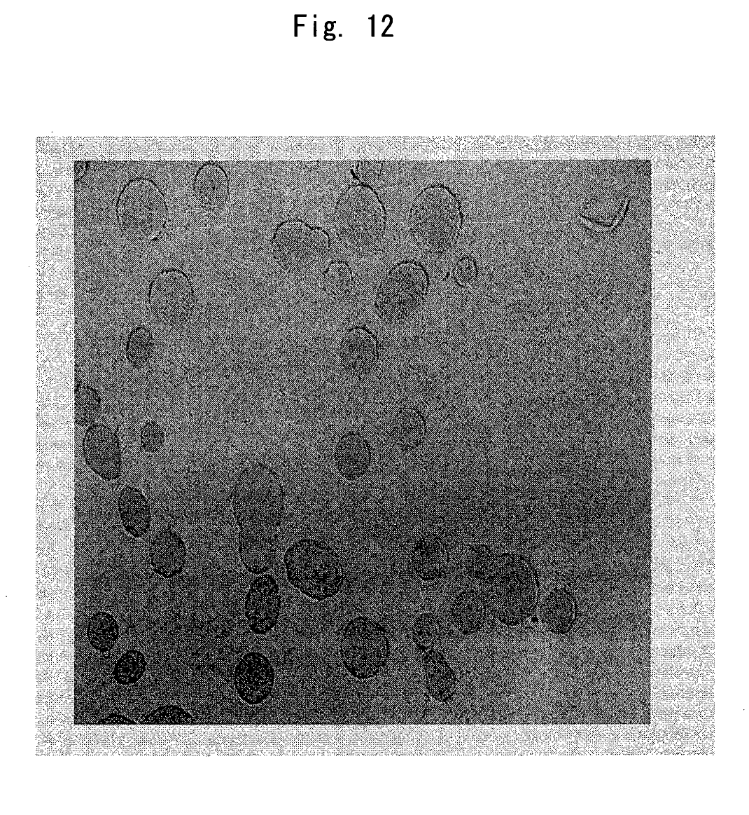

As shown in FIG. 12, a plurality of spot-shaped indents arising from peeling were formed in the surface of the thin-film magnetic layer 16, and the desired etching processing could not be completed.

The above results confirm the finding that reducing the ratio of the CO gas flow rate relative to the total flow rate of the reactive gas is effective in enabling high precision processing of fine etching target areas of a thin-film magnetic layer.

In the above example, the ratio of the CO gas flow rate relative to the total flow rate of the reactive gas was 12.5%, but the present invention is not limited to this ratio, and the ratio of the flow rate of CO gas relative to the total flow rate of the reactive gas can be set appropriately within the range from 1 to 40%, in accordance with the width of the etching target areas.

For example, if the width of the etching target areas is comparatively large, then increasing the CO gas flow rate ratio is unlikely to cause inhibition of the etching of the bottom surfaces within the grooves of the target areas, and furthermore the carbonylation of the magnetic material is also accelerated, meaning the etching speed can be improved.

In contrast, if the width of the etching target areas is comparatively narrow, then reducing the CO gas flow rate ratio prevents, or vastly reduces, any inhibition of the etching of the bottom surfaces within the grooves of the target areas, enabling reliable etching to proceed. For example, in the case of etching a fine area with a target width of 150 nm or less, the CO gas flow rate ratio is preferably reduced to 30% or less. Furthermore, in order to further improve the processing precision of this type of fine target area, the CO gas flow rate ratio is preferably reduced to 20% or less, and further reducing the CO gas flow rate ratio to 15% or less enables even greater processing precision.

Moreover, in order to ensure sufficient promotion of the carbonylation of the magnetic material and a sufficiently high level of productivity, the CO gas flow rate ratio is preferably set to a value of 5% or more. Furthermore, setting the CO gas flow rate ratio to a value of 10% or more is even more preferred in terms of achieving a more efficient etching of the magnetic material.

In those cases where etching is performed on a considerably wide etching target area of at least 150 nm for example, increasing the CO gas flow rate ratio to a value exceeding the above range may cause no particular problems in terms of production efficiency and processing precision.

However, the reactive ion etching method of the present invention is indispensable in situations requiring high precision and efficient fine processing of etching target areas of a magnetic material with target widths of 150 nm or less.

In other words, it is presumed that magnetic materials with grooves with a width of 150 nm or less formed therein have probably been produced using reactive ion etching techniques according to the present invention. Particularly in those case in which the width of such formed grooves is 100 nm or less, the probability that the magnetic material has been produced using reactive ion etching techniques according to the present invention is even higher.

In addition, if these types of fine etching target areas with narrow widths have been subjected to etching with the processed surfaces inclined at an angle of 45 to 85° relative to the surface, then the probability that the magnetic material has been produced using reactive ion etching techniques according to the present invention is even higher still. The magnetic recording medium being provided with the magnetic material such as above-described has a good characteristic in recording and reproducing for informations.

In order to reliably prevent peeling of the thin-film magnetic layer during the reactive ion etching, the temperature in the vicinity of the processing target body should preferably be maintained at 200° C. or lower, as described in the above embodiment, although most peeling of the thin-film magnetic layer can be prevented by maintaining the temperature in the vicinity of the processing target body at 300° C. or lower.

As described above, the present invention enables precise etching of fine etching target areas of a magnetic material with target widths of 150 nm or less.

What is claimed is:

1. A method for dry etching a magnetic material comprising the step of subjecting the magnetic material to fine processing by reactive ion etching using, as a reactive gas, carbon monoxide gas containing an added gas of a nitrogen based compound, wherein the ratio of the flow rate of the carbon monoxide gas relative to the total flow rate of the reactive gas is within a range from 1% to 40%.

2. The method for dry etching a magnetic material according to claim 1, wherein
the temperature in the vicinity of the magnetic material is maintained at 300° C. or lower, while the magnetic material is subjected to fine processing.

3. A magnetic material, wherein an etching target area thereof is etched using the method for dry etching a magnetic material comprising the step of subjecting the magnetic material to fine processing by reactive ion etching using, as a reactive gas, carbon monoxide gas containing an added gas of a nitrogen based compound, wherein the ratio of the flow rate of the carbon monoxide gas relative to the total flow rate of the reactive gas is within a range from 1% to 40%, and
the width of the etching target area is equal to, or less than, 150 nm.

4. The magnetic material according to claim 3, wherein
a processed surface is etched to be inclined at an angle of 45 to 85° relative to a surface of the material.

5. The magnetic material according to claim 3, wherein
the etching target-area is fine processed under the condition of the temperature in the vicinity thereof is maintained at 300° C. or lower.

6. A magnetic recording medium comprising the magnetic material, wherein an etching target area thereof is etched using the method for dry etching a magnetic material comprising the step of subjecting the magnetic material to fine processing by reactive ion etching using, as a reactive gas, carbon monoxide gas containing an added gas of a nitrogen based compound, wherein the ratio of the flow rate of the carbon monoxide gas relative to the total flow rate of the reactive gas is within a range from 1% to 40%, and
the width of the etching target area is equal to, or less than, 150 nm.

7. The magnetic recording medium according to claim 6, wherein
a processed surface is etched to be inclined at an angle of 45 to 85° relative to a surface of the material.

8. The magnetic recording medium according to claim 6, wherein the magnetic material is fine processed under the condition of the temperature in the vicinity thereof is maintained at 300° C. or lower.

9. A magnetic recording medium being provided with a magnetic material, wherein the magnetic material has an etching target area having the width thereof is equal to, or less that 150 nm and has a processed surface etched to be inclined at angle of 45° to 85° relative to a surface of the material.

10. A reactive ion etching device comprising:
a diffusion chamber for housing a processing target body;
reactive gas supply means for supplying carbon monoxide gas with an added gas of a nitrogen based compound as a reaction gas into the diffusion chamber and for restricting the ratio of the carbon monoxide gas flow rate relative to the total flow rate of the reactive gas to a value within a range from 1 to 40%; and
temperature adjustment means for maintaining the temperature in the vicinity of the magnetic material in the diffusion chamber at 300° C. or lower.
